(19) United States
(12) Patent Application Publication
(10) Pub. No.: US 2012/0170616 A1
(43) Pub. Date: Jul. 5, 2012

(54) Apparatus and Method for Sensing Temperature

(75) Inventors: Kun-Ju Tsai, Taichung City (TW); Shang-Yuan Lin, Kaohsiung City (TW); Shi-Wen Chen, Kaohsiung City (TW); Ming-Hung Chang, Tainan City (TW); Wei Hwang, Hsinchu City (TW)

(73) Assignee: INDUSTRIAL TECHNOLOGY RESEARCH INSTITUTE, Hsinchu (TW)

(21) Appl. No.: 13/117,487

(22) Filed: May 27, 2011

(30) Foreign Application Priority Data
Dec. 31, 2010 (TW) 99147342

(51) Int. Cl. G01K 7/00

(52) U.S. Cl. 374/163; 374/E07.001

(57) ABSTRACT

An apparatus and a method for sensing temperature are provided. The apparatus includes a first oscillation circuit, a pulse width generator, and a comparison circuit. The first oscillation circuit is for generating a first signal having a first frequency which is related to a to-be-sensed temperature. The pulse width generator is for generating a pulse width signal, the pulse width signal having a pulse width related to the to-be-sensed temperature. The comparison circuit is for generating an output signal indicative of the value of the to-be-sensed temperature according to the first signal and the pulse width signal.

### RELATED APPLICATION

This application claims the benefit of Taiwan application Serial No. 99147342, filed Dec. 31, 2010, the subject matter of which is incorporated herein by reference.

### TECHNICAL FIELD

The disclosure relates in general to an apparatus for sensing temperature, and more particularly to a fully on-chip all-digital apparatus for sensing temperature.

### BACKGROUND

Temperature information has a wide range of applications in lives of human beings. In the application of integrated circuits, a temperature sensor circuit is a core circuit responsible for issues such as chip's internal temperature monitoring, efficiency or performance compensation, or overheating protection.

Current temperature sensor circuits use a time-to-digital converter (TDC) to achieve temperature measurement. The TDC is included in some inverter circuits implemented by complementary-metal-oxide semiconductors (CMOS), where a near-linear relationship between temperature variation and signal delay in the inverter circuits is mainly relied on to establish a delay line for temperature measurement. However, in order to achieve sufficient temperature resolution, a large number of inverters are required in TDC to attain sufficient pulse delay. Thus, a temperature sensor circuit using TDC usually occupies large area and consumes high power.

### SUMMARY

Embodiments are disclosed for an apparatus and method for sensing temperature. Embodiments of the apparatus for sensing temperature use a frequency-to-digital converter (FDC) for temperature measurement, which results in a reduced area in chip. In an embodiment, the apparatus for sensing temperature uses two oscillation circuits which are operated at different operation regions, such as near-threshold and sub-threshold regions, thus becoming less affected by process variation. In an embodiment, an operation voltage could be of a low voltage, so that power consumption could be greatly reduced.

According to an aspect of the present disclosure, embodiments of an apparatus are provided for sensing temperature. The apparatus includes a first oscillation circuit, a pulse width generator, and a comparison circuit. The first oscillation circuit is configured to generate a first signal. The first signal has a first frequency related to a to-be-sensed temperature. An operation voltage of the first oscillation circuit is substantially equal to a threshold voltage of the first oscillation circuit. The pulse width generator is configured to generate a pulse width signal. The pulse width signal has a pulse width related to the to-be-sensed temperature. The comparison circuit is configured to receive the first signal and the pulse width signal, and generate an output signal indicative of the value of the to-be-sensed temperature according to the first signal and the pulse width signal.

According to another aspect of the present disclosure, embodiments of a method are provided for sensing temperature. The method includes a number of steps. A first signal is generated by setting a first oscillation circuit to have an operation voltage which is substantially equal to a threshold voltage of the first oscillation circuit. The first signal has a first frequency related to a to-be-sensed temperature. A pulse width signal is generated at a pulse width generator. The pulse width signal has a pulse width related to the to-be-sensed temperature. An output signal indicative of the value of the to-be-sensed temperature is generated according to the first signal and the pulse width signal.

According to another aspect of the present disclosure, embodiments of a method are provided for sensing temperature. The method includes a number of steps. A first signal is generated by setting a first oscillation circuit to have an operation voltage which is substantially equal to a threshold voltage of the first oscillation circuit. The first signal has a first frequency related to a to-be-sensed temperature. A second signal is generated by setting a second oscillation circuit to have an operation voltage which is substantially twice a threshold voltage of the second oscillation circuit. The second signal has a second frequency related to the to-be-sensed temperature. The first signal is compared with the second signal so as to generate an output signal indicative of the value of the to-be-sensed temperature.

According to some embodiments provided in any aspect aforementioned, the threshold voltage of the first oscillation circuit is substantially twice the threshold voltage of the second oscillation circuit, and the operation voltage of the first oscillation circuit is substantially equal to the operation voltage of the second oscillation circuit. Besides, in some embodiments, the value of the to-be-sensed temperature could be generated according to a ratio between the first frequency of the first signal and the second frequency of the second signal.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram showing an apparatus for sensing temperature according to an embodiment of the disclosure.

FIG. 2 is a schematic diagram showing the relationship between temperature variation and frequency of the apparatus for sensing temperature in FIG. 1.

FIG. 3 is a circuit diagram showing an apparatus for sensing temperature according to another embodiment of the disclosure.

FIG. 4 is a timing diagram of signals for use in the apparatus for sensing temperature in FIG. 3.

FIG. 5 is a flow chart showing a method for sensing temperature according to an embodiment of the disclosure.

FIG. 6 is a flow chart showing a method for sensing temperature according to another embodiment of the disclosure.

### DETAILED DESCRIPTION OF THE DISCLOSURE

Reference will now be made in detail to exemplary embodiments of the present disclosure for an apparatus and a method for sensing temperature. In an embodiment, the apparatus for sensing temperature includes a first oscillation circuit, a pulse width generator, and a comparison circuit. The first oscillation circuit is for generating a first signal. The first signal has a first frequency which is related to a to-be-sensed temperature. An operation voltage of the first oscillation circuit is substantially equal to a threshold voltage of the first oscillation circuit. In other words, the first oscillation circuit could be set to have the operation voltage which is substantially equal to its threshold voltage. The pulse width generator is for generating a pulse width signal. The pulse width signal has a pulse width related to the to-be-sensed temperature. The comparison circuit is for receiving the first signal and the pulse width signal, and for generating an output signal indicative of the value of the to-be-sensed temperature according to the first signal and the pulse width signal. In an embodiment, the apparatus for sensing temperature could be implemented as a fully on-chip all-digital process-invariant temperature sensor, which could for example be incorporated in an integrated circuit, such as a micro-processor, a chip for handheld devices, or other kind of integrated circuit.

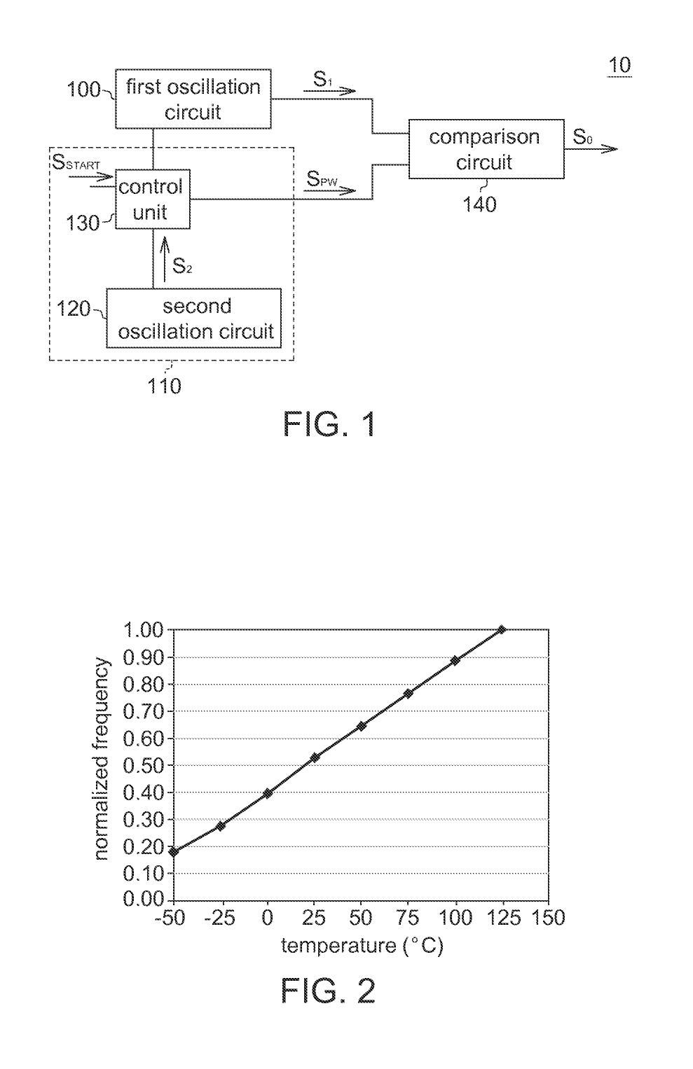

FIG. 1 is a block diagram showing an apparatus for sensing temperature according to an embodiment of the disclosure. As shown in FIG. 1, the apparatus for sensing temperature 10 includes a first oscillation circuit 100, a pulse width generator 110, and a comparison circuit 140.

The first oscillation circuit 100 generates a first signal S₁ and provides it for the comparison circuit 140. The first signal S₁ has a first frequency of f1 related to a to-be-sensed temperature of T. An operation voltage of the first oscillation circuit 100 is substantially equal to a threshold voltage of the first oscillation circuit 100. In an embodiment, the first oscillation circuit could be set to have an operation voltage which is approximately equal to the threshold voltage of the first oscillation circuit 100, while their difference exemplarily within a range of ±5˜10%. For example, if the threshold voltage of the first oscillation circuit 100 is around 0.4V, the first oscillation circuit 100 is set to have an operation voltage within a range from about 0.36V to about 0.44V, where transistors of the first oscillation circuit 100 are in the sub-threshold voltage region.

The pulse width generator 110 generates a pulse width signal S_{PW} and provides it for the comparison circuit 140. The pulse width signal S_{PW} has a pulse width related to the to-be-sensed temperature of T.

The comparison circuit 140 receives the first signal S₁ and the pulse width signal S_{PW}. According to the first signal S₁ and the pulse width signal S_{PW}, the comparison circuit 140 generates an output signal S₀ indicative of the value T of the to-be-sensed temperature.

The pulse width generator 110 includes a second oscillation circuit 120 and a control unit 130. The second oscillation circuit 120 generates a second signal S₂ and provides it for the control unit 130. The second signal S2 has a second frequency of f2 related to the to-be-sensed temperature of T. The control circuit 130 outputs the pulse width signal S_{PW} according to the second signal S₂. An operation voltage of the second oscillation circuit 120 is substantially twice a threshold voltage of the second oscillation circuit 120. In an embodiment, the second oscillation circuit could be set to have an operation voltage which is approximately twice as large as the threshold voltage of the second oscillation circuit 120. For example, if the transistors' threshold voltage of the second oscillation circuit 120 is around 0.2V, the second oscillation circuit 120 is set to have an operation voltage approximately equal to 0.4V, so that the operation voltage of the second oscillation circuit 120 is substantially twice as large as the threshold voltage of the second oscillation circuit 120.

The first oscillation circuit 100 and the second oscillation circuit 120 could be for example implemented as ring oscillators where a number of inverters are connected or linked in a chain. In a case that the first oscillation circuit 100, implemented by a number of inverters connected or linked in a chain, has an operation voltage which is substantially equal to transistors' threshold voltage of the first oscillation circuit 100, an equation could be established to describe the relation between the to-be-sensed temperature of T and the first frequency of f1 of the first signal S₁ generated by the first oscillation circuit 100, which is as follows

$$f 1 = \frac{{μ}_{0} {C}_{OX} \frac{W}{L} ( m - 1 ) {( {V}_{T} )}^{2} \times {e}^{( {V}_{GS} - {V}_{th 1} ) / m {V}_{T}}}{{V}_{DD} \times {C}_{L}}$$

where μ₀ is the carrier mobility, Cₒₓ is the oxide capacitance per unit area, W is the channel width of a transistor, L is the channel length of a transistor, m is the sub-threshold swing coefficient, V_{T} is the thermal voltage, V_{GS} is the gate-to-source voltage of a transistor, Vₜₕ₁ is the threshold voltage of the first oscillation circuit 100 at temperature of T, V_{DD} is the operation voltage, C_{L} is the load capacitance.

Moreover, in a case that the second oscillation circuit 120, implemented by a number of inverters connected or linked in a chain, has an operation voltage which is substantially higher than, e.g., twice as large as, a threshold voltage of the second oscillation circuit 120, an equation could be established to describe the relation between the to-be-sensed temperature of T and the second frequency of f2 of the second signal S₂ generated by the second oscillation circuit 120, which is as follows

$$f 2 = \frac{{μ}_{0} {C}_{OX} \frac{W}{L} {V}_{DS} \times ( {V}_{GS} - {V}_{th 2} - \frac{1}{2} {V}_{DS} )}{{V}_{DD} \times {C}_{L}}$$

where μ₀ is the carrier mobility, Cₒₓ is the oxide capacitance per unit area, W is the channel width of a transistor, L is the channel length of a transistor, V_{DS} is the drain-to-source voltage of a transistor, V_{GS} is the gate-to-source voltage of a transistor, Vₜₕ₂ is the threshold voltage of the second oscillation circuit 120 at temperature of T, V_{DD} is the operation voltage, C_{L} is the load capacitance.

In view of this, in a case that the first frequency of f1 of the first signal S₁ generated by the first oscillation circuit 100 is compared with the second frequency of f2 of the second signal S₂ generated by the second oscillation circuit 120, where the relation between the thermal voltage (V_{T}) and the temperature and the relations between threshold voltages and the temperature are introduced, an equation could be obtained as follows

$$\begin{matrix}TS ∝ \frac{f 1}{f 2} = \frac{( m - 1 ) {( {V}_{T} )}^{2} \times {e}^{( {V}_{GS} - {V}_{th 1} ) / m {V}_{T}}}{{V}_{DS} \times ( {V}_{GS} - {V}_{th 2} - \frac{1}{2} {V}_{DS} )} \\ = ( m - 1 ) {( \frac{K}{q} )}^{2} \times {T}^{2} \frac{{e}^{( {V}_{DD} - {V}_{th 1} ( 0 ) + α T / m {V}_{T} )}}{{V}_{DD} \times ( \frac{1}{2} {V}_{DD} - {V}_{th 2} ( 0 ) + α T )}\end{matrix}$$

Assume V_{DD}×(½V_{DD}−Vₜₕ₂(0)) is a constant of Kb, the result is given in an equation as follows

$$TS ∝ \frac{{KT}^{2}}{{K}_{b} + α T}$$

Furthermore, when the square of Kb is close to zero, the partial derivative of this equation with respect to the temperature of T could be given in an equation as follows

$$\begin{matrix}\frac{\partial TS}{\partial T} ∝ \frac{KT ( 2 {K}_{b} + α T )}{{( {K}_{b} + α T )}^{2}} \\ = \frac{KT ( 2 {K}_{b} + α T )}{{K}_{b}^{2} + α T ( 2 {K}_{b} + α T )} \\ ≅ \frac{KT}{α T} \\ = \frac{K}{α}\end{matrix}$$

As could be acknowledged from the aforementioned equation, the apparatus 10 for sensing temperature could generate an output signal which is sensitive and related to the to-be-sensed temperature by comparing the first frequency of f1 with the second frequency of f2. In view of this, there are other cases regarded as practicable and feasible embodiments of the disclosure, where what could found at least includes: generating a first frequency by setting the first oscillation circuit 100 to have an operation voltage which is substantially equal to a threshold voltage of the first oscillation circuit 100; generating a second frequency by setting the second oscillation circuit 120 to have an operation voltage which is substantially twice a threshold voltage of the second oscillation circuit 120; and using the comparison circuit 140 to compare the first frequency with the second frequency, so as to generate an output signal indicative of the value of the to-be-sensed temperature. As shown in FIG. 2, a linear relationship could be established between the to-be-sensed temperature of T and the frequency of the ratio signal of TS (TS ∝ f1/f2). In view of this, when comparing the first signal S₁ and the pulse width signal S_{PW}, the comparison circuit 140 could generate the output signal S₀, and the output signal S₀ could carry a digital code indicative of the to-be-sensed temperature.

Besides, in the first oscillation circuit 100 and the second oscillation circuit 120, their threshold voltages could be adjusted such that the apparatus 10 for sensing temperature could meet the requirement of being powered at a single voltage level or a single voltage domain. For example, the first oscillation circuit 100 and the second oscillation circuit 120 could both be ring oscillation circuits. A ring oscillation circuit has a threshold voltage which is related to the channel length of its transistor. In view of the relationship between a transistor's channel length and threshold voltage, the first oscillation circuit 100 and the second oscillation circuit 120 could be designed such that the threshold voltage of the first oscillation circuit 100 is twice the threshold voltage of the second oscillation circuit 120. Moreover, the first oscillation circuit 100 and the second oscillation circuit 120 could be connected to a voltage source for receiving an operation voltage which is substantially equal to the threshold voltage of the first oscillation circuit 100, thus meeting the requirement of being powered at a signal voltage level or a single voltage domain.

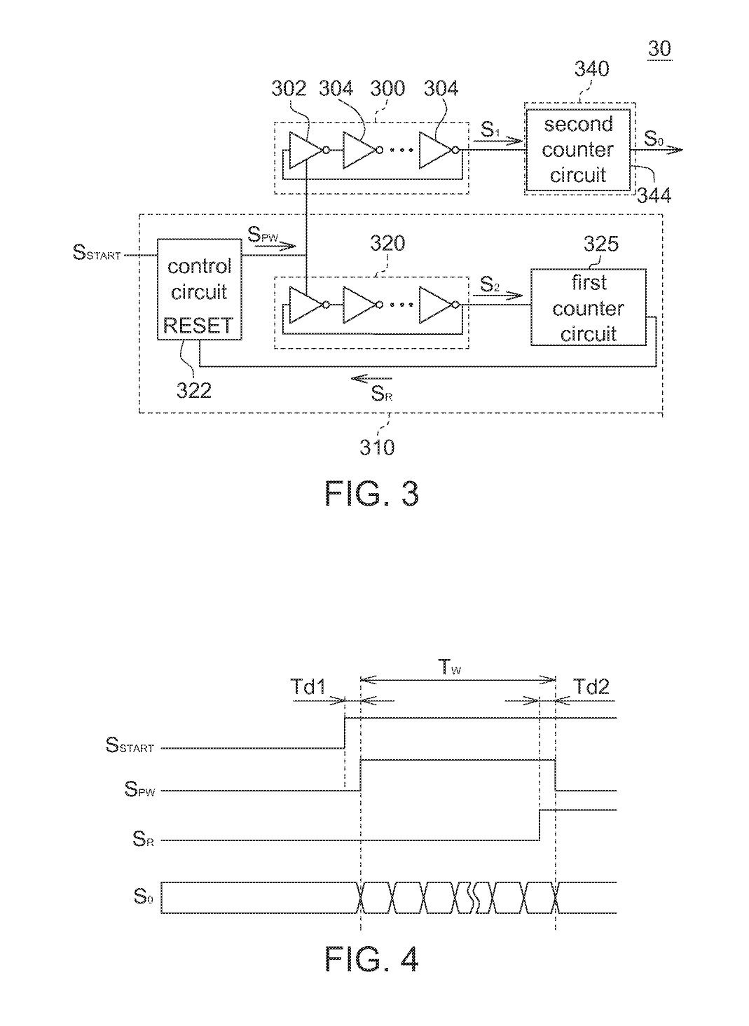

Refer to both FIGS. 3 and 4. FIG. 3 is a circuit diagram showing an apparatus for sensing temperature according to another embodiment of the disclosure. FIG. 4 is a timing diagram of signals for use in the apparatus for sensing temperature in FIG. 3. As shown in FIG. 3, the apparatus 30 for sensing temperature includes a first oscillation circuit 300, a pulse width generator 310, and a comparison circuit 340. The first oscillation circuit 300 is for example a ring oscillation circuit, which includes an enable-pin-based inverter 302, having a means or mechanism for being enabled or disabled (e.g., tri-state inverter or tri-state buffer), and includes a number of inverters 304 connected or linked in chain. The pulse width generator 310 includes a second oscillation circuit 320, a control circuit 322, and a first counter 325. The comparison circuit 340 is for example a second counter 344.

Refer to FIG. 4. The apparatus 30 for sensing temperature could receive a start signal S_{START} which is used to enable the apparatus 30 and is received for example at the control circuit 322. A first delay time Td1 after the start signal S_{START} transits from low to high level, the pulse width signal S_{PW} that the control circuit 322 outputs to the first oscillation circuit 300 and the second oscillation circuit 320 will transit from low level to high level. The pulse width signal S_{PW} which transits from low level to high level will enable the first oscillation circuit 300, causing the first oscillation circuit 300 to output a first signal S₁ to the comparison circuit 340 according to the to-be-sensed temperature of T. The first signal S₁ has a first frequency of f1.

In the meanwhile, the second oscillation circuit 320 of the pulse width generator 310 outputs a second signal S₂ having a second frequency of f2 to the first counter 325, where the second frequency of f2 is related to the to-be-sensed temperature of T. When the first counter 325 counts pulses of the second signal S₂ up to a predetermined value of n, n being a positive integer, the first counter 325 outputs a high-level reset signal S_{R} to the control circuit 322 at its reset terminal RESET. A second delay time Td2 after the control circuit 322 receives the high-level reset signal S_{R} at its reset terminal RESET, the pulse width signal S_{PW} of the control circuit 322 transits from high to low level, which causes the pulse width signal S_{PW} to have a period Tw of high level. The high-level period Tw of the pulse width signal S_{PW} could be represented by n/f2.

When the pulse width signal S_{PW} of the control circuit 322 transits from low to high level, the second counter 344 starts to count up pulses of the first signal S₁. When the pulse width signal S_{PW} of the control circuit 322 transits from high to low level, the second counter 344 represents or characterizes the counted pulses as the to-be-sensed temperature of T, and outputs it by generating the output signal S₀. For example, during the high-level period Tw of the pulse width signal S_{PW}, if the counted pulse number of the first signal S₁ is a value of m, m being a positive integer, the value of m could be used to represent a measurement of the to-be-sensed temperature of T. The high-level period Tw of the pulse width signal S_{PW} could be represented by m/f1, so that the value of m could be represented by n×f1/f2.

Thus, when the first oscillation circuit 300 is set to have an operation voltage substantially equal to the threshold voltage of the first oscillation circuit 300, its generated first signal S₁ will have a first frequency of f1 directly propositional to the square of the to-be-sensed temperature of T. Moreover, when the second oscillation circuit 320 is set to have an operation voltage substantially twice the threshold voltage of the second oscillation circuit 320, its generated second signal S₂ will have a second frequency of f2 directly propositional to the to-be-sensed temperature of T to the power of 1. Based on them, the comparison circuit 340 could generate a value of m which is equal to n×f1/f2, i.e., generate an output signal S₀ related to the to-be-sensed temperature of T. Moreover, in a practical example where that the first counter circuit 325 uses the predetermined number of n to count pulses of the second signal S₂, the predetermined number of n could be adjusted so as to increase or decrease resolution accordingly.

Where the first oscillation circuit 300 is implemented by for example a single-stage enable-pin-based inverter 302 and 12-stage inverters 304, while the second oscillation circuit 320 is implemented by for example a single-stage enable-pin-based inverter and 50-stage inverters, powered at a signal voltage level such as a voltage level around 0.4V, the apparatus 30 for sensing temperature could generate an 11-bit output signal S₀, with a data conversion rate of 14 k/s. Besides, where the first oscillation circuit 300 is implemented by for example a single-stage enable-pin-based inverter 302 and 14-stage inverters 304, while the second oscillation circuit 320 is implemented by for example a single-stage enable-pin-based inverter and 30-stage inverters, the apparatus 30 for sensing temperature could generate a 10-bit output signal S₀, with a higher data conversion rate of 22 k/s. While the disclosure has been described in aforementioned embodiments in terms of the stages of the oscillations circuits, it, however, is not limited thereto. In view of the content described above, it is practicable and feasible for a person of ordinary skill to realize an oscillation circuit having an appropriate number of stages for use in various ranges of to-be-sensed temperature.

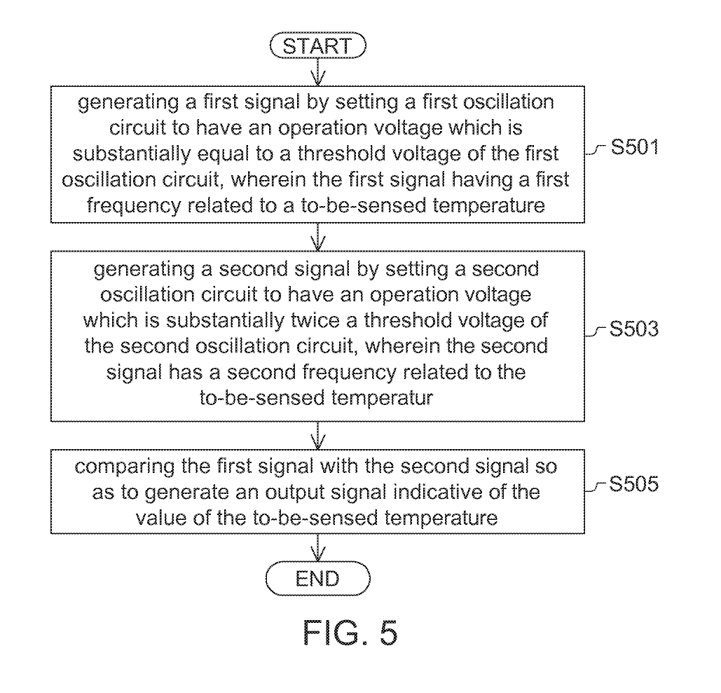

FIG. 5 is a flow chart showing a method for sensing temperature according to an embodiment of the disclosure. In step S501, a first signal is generated by setting a first oscillation circuit to have an operation voltage which is substantially equal to a threshold voltage of the first oscillation circuit. The first signal has a first frequency related to a to-be-sensed temperature.

In step S503, a second signal is generated by setting a second oscillation circuit to have an operation voltage which is substantially twice a threshold voltage of the second oscillation circuit. The second signal has a second frequency related to the to-be-sensed temperature. In step S505, the first signal is compared with the second signal so as to generate an output signal indicative of the value of the to-be-sensed temperature.

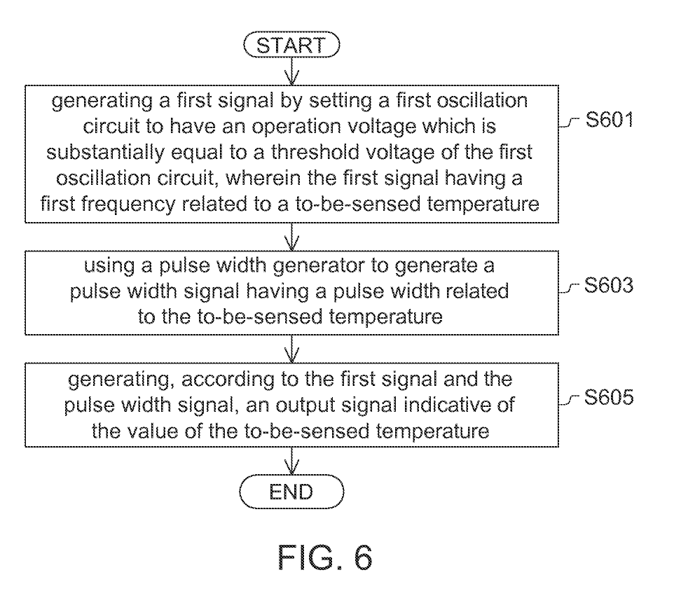

FIG. 6 is a flow chart showing a method for sensing temperature according to another embodiment of the disclosure. In step S601, a first signal is generated by setting a first oscillation circuit to have an operation voltage which is substantially equal to a threshold voltage of the first oscillation circuit. The first signal has a first frequency related to a to-be-sensed temperature. In step S603, a pulse width generator is used to generate a pulse width signal. The pulse width signal has a pulse width related to the to-be-sensed temperature. In step S605, according to the first signal and the pulse width signal, an output signal indicative of the value of the to-be-sensed temperature is generated.

According to the embodiments of the apparatus for sensing temperature disclosed in the disclosure, a frequency-to-digital converter (FDC) is used to generate the measurement of a to-be-sensed temperature. In this way, as compared with that of using TDC to achieve temperature measurement, the circuit complexity is reduced. Thus, the apparatus for sensing temperature could be realized in smaller size. Besides, according to the embodiments of the apparatus for sensing temperature disclosed in the disclosure, the first oscillation circuit and the pulse width generator could be operated at a sub-threshold voltage region and a near-threshold voltage region, respectively, and could be powered at a relatively low operation voltage, so that power consumption could be greatly reduced.

Besides, according to an embodiment aforementioned, the measurement value of m is equal to n×f1/f2, or equal to n×K/a in view of the partial derivative with respect to the temperature, and is linearly related to the temperature, thus becoming less affected by, or preferably immune to, the process variation. For example, if an embodiment of the apparatus for sensing temperature is implemented from a different production process, the generated signal of the oscillation circuit will have a different frequency in view of a same temperature. In this situation, since the embodiment of the apparatus for sensing temperature could establish a linear relationship between the temperature and the measurement value of m, the digital output signal thereof could remain substantially the same, thus becoming immune to the process variation. For example, in a process of using TSMC standard 65nm CMOS technology, simulation result shows that there is a measurement error ranges between −2.8˜+3.0 in a measurement range of 0˜100, although the process variation causes some apparatuses for sensing temperature to have a different corresponding result between frequency and temperature. Therefore, the embodiments according to the disclosure could realize a fully on-chip all-digital process invariant apparatus for sensing temperature.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for sensing temperature, the apparatus comprising:
a first oscillation circuit configured to generate a first signal, the first signal having a first frequency related to a to-be-sensed temperature, wherein an operation voltage of the first oscillation circuit is substantially equal to a threshold voltage of the first oscillation circuit;
a pulse width generator configured to generate a pulse width signal, the pulse width signal having a pulse width related to the to-be-sensed temperature; and
a comparison circuit configured to receive the first signal and the pulse width signal, and generate an output signal indicative of the value of the to-be-sensed temperature according to the first signal and the pulse width signal.

2. The apparatus according to claim 1, wherein the pulse width generator comprises:
a second oscillation circuit configured to generate a second signal, the second signal having a second frequency related to the to-be-sensed temperature; and
a control circuit configured to make the pulse width generator output the pulse width signal according to the second signal, wherein an operation voltage of the second oscillation circuit is substantially twice a threshold voltage of the second oscillation circuit.

3. The apparatus according to claim 2, wherein the pulse width generator further comprises:
a first counter circuit configured to count up pulses of the second signal, and output a reset signal according to the counted pulse number of the second signal.

4. The apparatus according to claim 2, wherein the threshold voltage of the first oscillation circuit is substantially twice the threshold voltage of the second oscillation circuit, and the operation voltage of the first oscillation circuit is substantially equal to the operation voltage of the second oscillation circuit.

5. The apparatus according to claim 1, wherein the comparison circuit comprises a second counter circuit configured to generate the output signal by counting up pulses of the first signal according to the pulse width signal.

6. The apparatus according to claim 2, wherein the first oscillation circuit and the second oscillation circuit both are ring oscillation circuits.

7. A method for sensing temperature, comprising:
generating a first signal by setting a first oscillation circuit to have an operation voltage which is substantially equal to a threshold voltage of the first oscillation circuit, the first signal having a first frequency related to a to-be-sensed temperature;
generating, at a pulse width generator, a pulse width signal, the pulse width signal having a pulse width related to the to-be-sensed temperature; and
generating an output signal indicative of the value of the to-be-sensed temperature according to the first signal and the pulse width signal.

8. The method according to claim 7, wherein the pulse width generator comprises a second oscillation circuit, and an operation voltage of the second oscillation circuit is substantially twice a threshold voltage of the second oscillation circuit.

9. The method according to claim 8, wherein the step of generating the pulse width signal comprises:
generating, at the second oscillation circuit, a second signal, the second signal having a second frequency related to the to-be-sensed temperature; and
generating the pulse width signal according to the second signal.

10. The method according to claim 9, wherein the step of generating the pulse width signal according to the second signal comprises:
outputting a reset signal by counting up pulses of the second signal; and
outputting the pulse width signal according to the reset signal.

11. The method according to claim 8, wherein the threshold voltage of the first oscillation circuit is substantially twice the threshold voltage of the second oscillation circuit, and the operation voltage of the first oscillation circuit is substantially equal to the operation voltage of the second oscillation circuit.

12. The method according to claim 8, wherein the first oscillation circuit and the second oscillation circuit both are ring oscillation circuits.

13. The method according to claim 7, wherein the step of generating the output signal comprises:
generating the output signal by counting up pulses of the first signal according to the pulse width signal.

14. A method for sensing temperature, comprising:
generating a first signal by setting a first oscillation circuit to have an operation voltage which is substantially equal to a threshold voltage of the first oscillation circuit, the first signal having a first frequency related to a to-be-sensed temperature;
generating a second signal by setting a second oscillation circuit to have an operation voltage which is substantially twice a threshold voltage of the second oscillation circuit, the second signal having a second frequency related to the to-be-sensed temperature; and
comparing the first signal with the second signal so as to generate an output signal indicative of the value of the to-be-sensed temperature.

15. The method according to claim 14, wherein the threshold voltage of the first oscillation circuit is substantially twice the threshold voltage of the second oscillation circuit, and the operation voltage of the first oscillation circuit is substantially equal to the operation voltage of the second oscillation circuit.

16. The method according to claim 15, wherein the step of comparing the first signal with the second signal so as to generate the output signal comprises generating the output signal according to a ratio between the first frequency of the first signal and the second frequency of the second signal.

17. The method according to claim 14, wherein the step of comparing the first signal with the second signal so as to generate the output signal comprises generating the output signal according to a ratio between the first frequency of the first signal and the second frequency of the second signal.
